(19) United States
(12) Patent Application Publication
(10) Pub. No.: US 2006/0187559 A1
(43) Pub. Date: Aug. 24, 2006

(54) Device for controlling the position of an optical lens

(75) Inventor: Aukje Arianne Annette Kastelijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/563,642

(22) PCT Filed: Jun. 30, 2004
(86) PCT No.: PCT/IB04/51075

§ 371 Date: Jan. 6, 2006

(30) Foreign Application Priority Data
Jul. 8, 2003 (EP) 03102045.6

(51) Int. Cl. G02B 7/02

(52) U.S. Cl. 359/819

(57) ABSTRACT

A device for controlling the position and/or orientation of an optical lens. The device comprises a first body (113) and a second body (115) carrying the optical lens (117). An elastic suspension system (119a) is provided for suspending the second body from the first body. The suspension system has a portion secured to the first body and another portion connected to the second body and has a functional length extending between the two portions. A driving unit is provided for driving the second body with regard to the first body. In order to vary the stiffness of the suspension system, the device comprises an adjusting unit (120) for adjusting the functional length of the suspension system.

The invention relates to a device for controlling the position and/or the orientation of an optical lens. Such a device comprises a first body, a second body for supporting or comprising the optical lens, and an elastic suspension system for suspending the second body from the first body, the suspension system having a portion connected to the first body and another portion connected to the second body and having a functional length extending between said two portions. Such a device further comprises a driving unit for driving the second body with respect to the first body.

US 2001/0030815 A1 discloses an optical pick-up actuator which includes a lens holder assembly suspended from a frame by a plurality of wire springs and having tracking coils and a focusing coil. The frame supports a magnet and a magnetic yoke. If an electric current flows along the focusing coil in this pick-up actuator, an electromotive force is generated such that the lens holder assembly is driven in focusing directions. Identically, if an electric current flows along the tracking coils, an electromotive force is generated such that the lens holder assembly is driven in tracking directions.

Each device of the kind described above has a natural frequency which is partly determined by the stiffness of the elastic suspension system. The other parameter determining the natural frequency is the moving mass, as is generally known.

In order to prevent undesired vibrations of the device, the natural frequency should have a predetermined value. However, this value varies for different applications. The natural frequency should be as low as possible for applications with mostly internal disturbances. Internal disturbances originate from a non-ideal situation within the application itself. In the field of optical recording such disturbances may be caused by an optical disc to be scanned which is not entirely flat, which has no perfectly circular tracks, which has a center that does not coincide with the rotation axis, or which has other internal deficiencies.

In an optical recording and/or reproducing system, the frequency content of internal disturbance signals contains mainly the rotation frequency of the disc and higher orders of this rotation frequency. Typical rotation frequencies are 3 to 10 Hz for Audio CD and 10 to 40 Hz for DVD.

In accordance with an accepted standard, the rotation frequency of the discs in these systems is not constant, as these systems operate with a constant linear velocity. Thus the rotation frequency at a more inner radius is different from the rotation frequency at a more outer radius. In applications with more external disturbances, i.e. disturbances acting on the device from the outside, the frequency content varies, but usually there is some consistency for a typical use. For example, when a CD player is used during jogging, the greatest external disturbances generally have a frequency that matches the jogging frequency. Other examples of causes of external disturbances are shocks due to dropping of an apparatus and vibrations in or of cars having a built-in optical player.

Generally speaking, the external disturbances require a higher natural frequency than do the internal disturbances.

As will be clear from the above analysis, the known optical pick-up actuator suffers from the problem that the wire suspension used has a natural frequency which is tuned to match a certain application but then is not very suitable for another, different application.

Thus, for example, a system that is tuned for a portable use in which jogging or dropping causes major disturbances will not perform optimally in a car.

An object of the invention is to improve the device as described in the preamble such that it is suitable for mutually quite different applications involving different types of disturbances.

This object is achieved by the device for controlling the position and/or orientation of an optical lens which device comprises a first body, a second body for supporting or comprising the optical lens, an elastic suspension system for suspending the second body from the first body, which suspension system has a portion connected to the first body and another portion connected to the second body and has a functional length extending between said two portions, a driving unit for driving the second body with regard to the first body, and an adjusting unit for adjusting the functional length of the elastic suspension system.

This device according to the invention is thus provided with a tool to adapt the functional length of the suspension system to the application of the device. The functional length is reduced if a higher stiffness of the suspension system is required and increased if a lower stiffness is required. This means, translated to the dynamic properties of the device, that the natural frequency can be easily changed by adjusting the functional length of the suspension system. It is to be noted that the term “functional length” in this paper denotes the length of the suspension system which is active during the movements of the second body with regard to the first body.

In a practical embodiment of the device according to the invention, the adjusting unit comprises an actuator fixed to one of the bodies and having a variable dimension, considered from the one body toward the other body, by means of which actuator one of the portions of the elastic suspension system is secured to the one of the bodies. Preferably, the actuator is secured to the first body, which may be a frame of the device. In this case the suspension system will be secured to the second body.

An embodiment has the characterizing feature that the actuator comprises a memory metal element. Such an element is known per se.

Alternatively, the actuator comprises a piezo element. Such an element is known per se.

It is generally known to apply a linear elastic suspension system in optical pick-ups. Particularly, such a system comprises one or two pairs of wire or blade springs. The adjusting unit disclosed in this paper can be successfully combined with a linear suspension system comprising one or more wire or blade springs.

The relationship between the natural frequency of an embodiment of the device according to the invention, which comprises a wire spring as its suspension, and the functional length of this wire spring will be elucidated hereinafter.
(1) S=3.E.I/L³, where S is the stiffness in N/m, E is the modulus of elasticity in N/m², I is the second moment of area in m⁴, and L is the functional length in m.
(2) fₙ=1/2π·\sqrt{(S/M)} and thus
(3) fₙ=1/2π·\sqrt{(3EI/ML³)}, with fₙ being the natural frequency of the device, and M the moving mass in kg.

It can be derived from equation (3) how a change in the functional length changes the natural frequency of the device. It is noted for the sake of completeness that a similar relationship exists if the suspension system comprises two or more springs.

In a preferred embodiment, the device according to the invention comprises a suspension controller for controlling the adjusting unit in dependence on a signal identifying a characteristic of a disturbance. The suspension controller may be part of a servo system that is known per se.

The invention also relates to an optical recording and/or reproducing apparatus which comprises the device according to the invention.

With reference to the claims, it is noted that various combinations of characteristic features defined in the Claims are possible.

The above-mentioned and other aspects of the invention are apparent from and will be elucidated, by way of non-limitative example, with reference to the embodiments described hereinafter.

In the drawings:

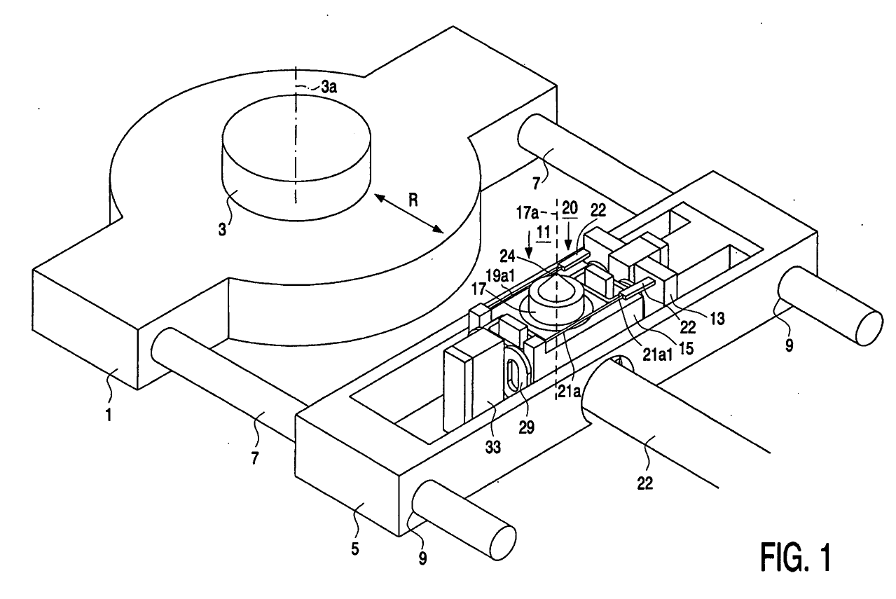

FIG. 1 is a perspective view of an embodiment of the apparatus according to the invention, diagrammatically shown,

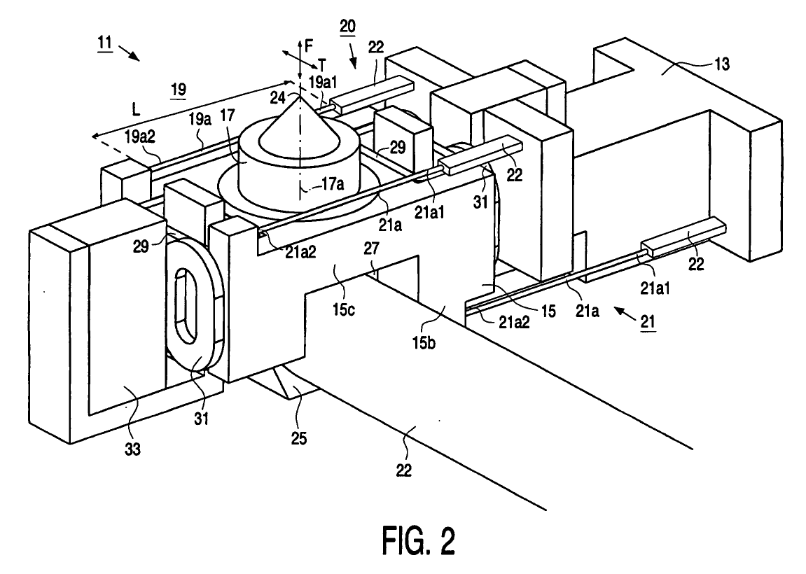

FIG. 2 is a perspective view of a first embodiment of the device according to the invention, diagrammatically shown,

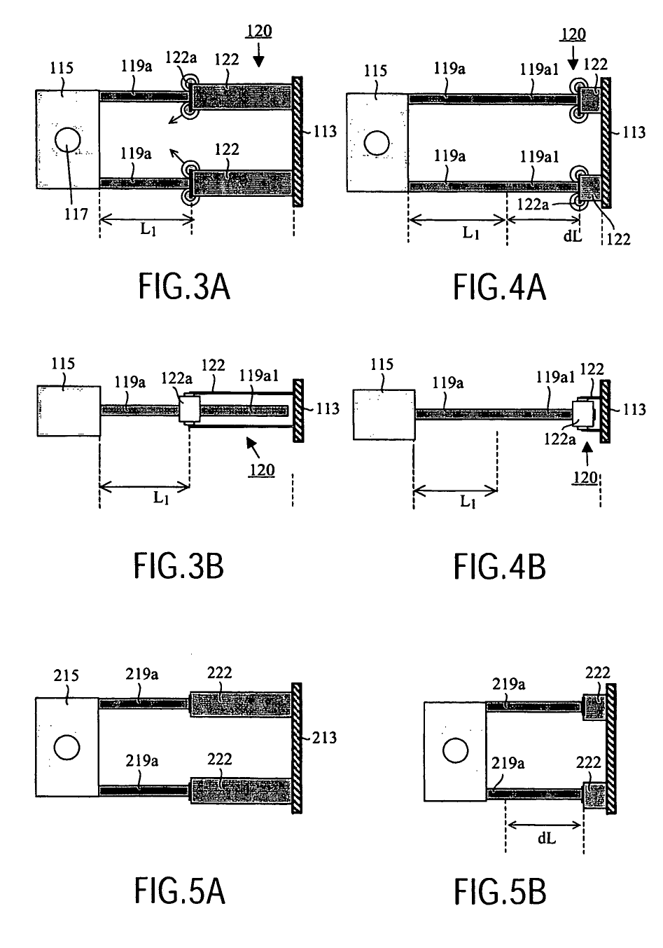

FIG. 3A is a diagrammatic plan view of a second embodiment of the device according to the invention, its suspension system having a first stiffness,

FIG. 3B is a diagrammatic side view of the second embodiment of the suspension system having the first stiffness,

FIG. 4A is a diagrammatic plan view of the second embodiment, the suspension system having a second stiffness,

FIG. 4B is a diagrammatic side view of the second embodiment, the suspension system having the second stiffness,

FIG. 5A is a diagrammatic plan view of a third embodiment of the device according to the invention, its suspension system having a first stiffness,

FIG. 5B is a diagrammatic side view of the third embodiment, the suspension system having a second stiffness, and

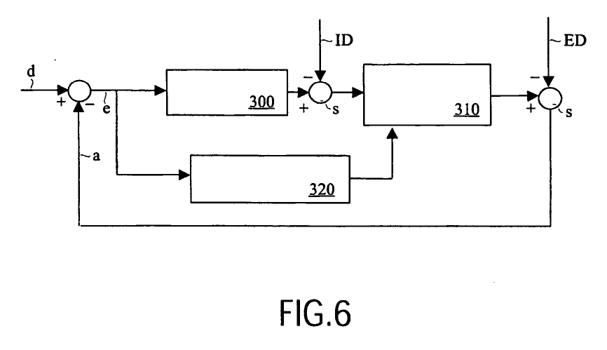

FIG. 6 is a schematic block diagram of a circuit for controlling of the adjusting unit.

FIGS. 1 and 2 show a part of an optical apparatus, in particular the deck of the apparatus, in which an embodiment 11 of the device according to the invention is used. The embodiment 11 will also be called scanning device 11 hereinafter.

The apparatus comprises a chassis 1 carrying an electrically drivable turntable 3 for supporting and centering an optical disc having an information track, for example a CD or DVD. The turntable 3 is rotatable about an axis of rotation 3a. The apparatus further comprises a slide 5 and a mechanical guide means for translating the slide 5 in a radial direction—indicated by the double arrow R—relative to the turntable 3. The guide means comprises, for example, two guide rods 7 secured to the chassis 1, which guide rods are adapted to cooperate with sliding sleeves of the slide 5. An electric motor, not shown, is supported by the chassis and serves for driving the slide 5 directly or by means of a transmission mechanism. Mechanisms which are known per se may be used for these purposes. Alternatively, a swing-arm device may be applied instead of a slide.

The slide 5 carries the scanning device 11, which comprises a first body 13 fixed to the slide 5 and a second body 15 comprising an objective lens 17 having an optical axis 17a parallel to the axis of rotation 3a of the turntable 3. The second body, also called movable body, 15 is connected to the first body, also called stationary body, 13 by means of a compliant suspension system, having two pairs 19; 21 of elastically deformable rod-like elements in the form of metal or plastics wire springs 19a; 21a of round, rectangular or differently shaped cross-section. The wires 19a, 21a, are mutually parallel and have substantially the same length. Only one wire 19a is visible in the Figures.

Each wire 19a, 21a, has a first fixing portion 19a1, 21a1 cooperating with an adjusting unit 20 which is mounted to the stationary body 13, and a second fixing portion 19a2, 21a2 fixed to the movable body 15. The adjusting unit 20 will be described in more detail with reference to FIGS. 3A, 3B, 4A, 4B. In this example the adjusting unit 20 comprises four actuators 22, each connected to one of the wires 19a, 21a. The fixation of the wires 19a, 21a to the movable body 15 may be realized by embedding their wire ends in plastics portions of the body 15, e.g. by means of an injection-molding process.

The two wires 19a form a first compliant supporting structure and the two wires 21b form a second compliant supporting structure for the movable body 15, both structures having an adjustable functional length L. During use, a laser beam 22 may approach the device in a direction corresponding to a radial direction R. Since the laser beam should pass the objective lens 17 along the optical axis 17a, a prism, not shown, may be provided to deflect the laser beam 22. The objective lens 17 converges the deflected laser beam into a focusing spot 24. A laser source may be a component of either the apparatus or the scanning device.

The scanning device 11 comprises a drive means for driving the movable body 15 relative to the stationary body 13. This drive means includes a coil portion installed on the movable body 15 and comprising a focusing coil arrangement 29 for moving the movable body 15 in a focusing direction—indicated by the double arrow F—and a tracking coil arrangement 31 for moving the movable body 15 in a tracking direction—indicated by the double arrow T. Said means further includes a magnetic portion installed on the stationary body 13 and comprising a magnet—yoke arrangement 33. The drive means may be of a known type.

The device for controlling the position and/or orientation of an optical lens, disclosed in FIGS. 3A, 3B, 4A, 4B, comprises a first, stationary body 113 in the form of a stationary or quasi-stationary frame, a second, movable body 115 in the form of a lens holder, an elastic suspension system formed by a pair of wires 119a, an adjusting unit 120 for adjusting the functional length of the suspension system, and a driving unit not shown in these Figures. Such a driving unit may correspond to the drive means used in the embodiment shown in FIGS. 1 and 2. The wires 119a are secured at one end to the second body 115 and each have an end portion 119a1 which can be held by a stiff actuator 122 of the adjusting unit 120. The actuators 122 have the characterizing feature that they are capable of lengthening and shortening themselves. For this purpose the actuators are made from a memory material or a piezoelectric material, which materials are known per se. The actuators 122 are each provided with a clamping, grasping or seizing means or the like in order to firmly hold the wires at their end portions 119a1. In this example, such means are formed by clamping rollers 122a. During lengthening or shortening of the actuators 122, the clamping rollers 122a move along the wires 119a from the one clamped position, e.g. as shown in FIGS. 3A, 3B, to another clamped position, e.g. as shown in FIGS. 4A, 4B. The wires 119a have a functional length L₁ in the position shown in FIGS. 3A, 3B. In the position shown in FIGS. 4A, 4B, this length is L₁+dL, wherein dL is the added active portion of the wires 119a. In this way the stiffness of the wires 119a, and thus of the suspension system can be varied, while keeping an optical lens 117 in its position. For practical reasons the extremity of the end portion 119a1 may be adhered to the body 113.

An alternative embodiment is shown in FIGS. 5A, 5B. This device has a stationary first body 213 and a second body 215 that is movable with regard to the first body 213 by means of a linear suspension system 220. The suspension system 220 comprises two elastic rod-like elements 219a, each having one end attached to the movable body 215 and another end attached to an actuator 222 mounted to the stationary body 213. The actuators 222 comprises a memory metal element or a piezo element and can thus be made longer and shorter. In this embodiment the actuators 222 are elastic in directions perpendicular to the length direction of the rod-like elements 219a and are a part of the suspension system. Activating the actuators causes their lengths to change from e.g. the length shown in FIG. 5A to the reduced length shown in FIG. 5B, thus over a distance dL. This change in length causes a change in stiffness of the suspension system. An undesired effect of this embodiment may be that the position of a lens 217 carried by the body 215 changes owing to the lengthening or shortening of the actuators 222.

To tune the natural frequency of the device for or during a specific use, e.g. use during jogging, or use in a car, a signal is needed that identifies the characteristics of the disturbances. The focus and/or radial error of the servosystem used shows a frequency content that matches the frequency content of the disturbance signal. Thus this signal can be used to tune the natural frequency. An example of a control is shown in FIG. 6.

FIG. 6 is a diagram of a control system for tuning the natural frequency of the suspension system of the device according to the invention. The system comprises a focus and/or radial controller 300, mechanical unit 310, comprising inter alia an actuator, a lens holder and a lens, and a suspension controller 320. During use, an error signal e, defined as the difference between the desired and the actual spot position, is generated by subtracting an actual spot position signal a from a desired spot position signal d. The error signal e is guided to the controller 300 and is converted into a current supplied to a coil system of the mechanical unit 320. Internal disturbances ID, if any, and/or external disturbances ED, if any, are added to the control system in summation points s. Thus the error signal e has a frequency content which matches the frequency content of the disturbances. For this reason the error signal e is suitable to be used for tuning the natural frequency. As can be seen in the block diagram, the error signal e is supplied to the suspension controller 320. This controller 320 may contain a filter to determine the frequency content of the error signal e. A lookup table or the like may be used in order to find the right suspension mode that matches the measured frequency content. In this way, the controller 320 is able to address an adjusting unit for adjusting the functional length of a suspension system in order to maintain the desired stability of the device according to the invention in spite of the presence of disturbances. The adjusting unit may embodied as the units 20 or 120, may comprise the actuators 222, or may be of some other suitable design. In the block system as depicted in FIG. 6, the adjusting unit is considered to be a part of the mechanical unit 310.

It is to be noted that the invention is not limited to the examples disclosed herein. For example, a device with a suspension system formed by one or more blade springs is also an option. Moreover, use may be made of servosystems known per se.

1. A device for controlling the position and/or orientation of an optical lens, which device comprises
a first body,
a second body for supporting or comprising the optical lens,
an elastic suspension system for suspending the second body from the first body, which suspension system has a portion connected to the first body and another portion connected to the second body and has a functional length extending between said two portions,
a driving unit for driving the second body with regard to the first body, and
an adjusting unit for adjusting the functional length of the elastic suspension system.

2. A device as claimed in claim 1, wherein the adjusting unit comprises an actuator fixed to one of the bodies and having a variable dimension, considered from the one body toward the other body, by means of which actuator one of the portions of the elastic suspension system is secured to the one of the bodies.

3. A device as claimed in claim 2, wherein the actuator is provided with a clamping unit for clamping the one of the portions of the elastic suspension system.

4. A device as claimed in claim 2, wherein the actuator comprises a memory metal element.

5. A device as claimed in claim 2, wherein the actuator comprises a piezo element.

6. A device as claimed in claim 1, wherein the elastic suspension system is a linear suspension system.

7. A device as claimed in claim 6, wherein the suspension system comprises a wire or blade spring.

8. A device as claimed in claim 6, wherein the suspension system comprises at least one pair of wire or blade springs.

9. A device as claimed in claim 2, wherein said one of the bodies is the first body.

10. A device as claimed in claim 1, characterized by the presence of a suspension controller for controlling the adjusting unit in dependence on a signal identifying a characteristic of a disturbance.

11. An optical recording and/or reproducing apparatus comprising the device as claimed in claim 1.
